(19) United States
(12) Patent Application Publication
(10) Pub. No.: US 2025/0313265 A1
(43) Pub. Date: Oct. 9, 2025

(54) AUGMENTED FRONT IMPACT PROTECTION USING A VEHICLE SUBFRAME

(71) Applicant: Fisker Inc., Manhattan Beach, CA (US)

(72) Inventors: Umachandran Muralidharan, Manhattan Beach, CA (US); Anthony Bray-Cotton, Manhattan Beach, CA (US); Dhruv Parmar, Manhattan Beach, CA (US)

(21) Appl. No.: 18/627,677

(22) Filed: Apr. 5, 2024

(51) Int. Cl. B62D 21/15; B60R 19/24; B62D 21/02; B62D 21/11

(52) U.S. Cl. CPC B62D 21/155; B62D 21/02; B62D 21/11; B60R 19/24

(57) ABSTRACT

The technology disclosed herein enables enhanced front impact protection for a vehicle. In a particular example, an apparatus includes a pair of longitudinal beams extending forward from a unibody structure of the vehicle. The pair of longitudinal beams are configured to crush towards the unibody structure during an impact. The apparatus further includes a subframe mounted to the vehicle below the pair of longitudinal beams. The subframe includes an additional pair of beams parallel to the pair of longitudinal beams and the additional pair of beams include indents for encouraging the additional pair of beams to bend during the impact.

### BACKGROUND

A paradigm shift in vehicle design and construction occurred when traditional body-on-frame architectures, once prevalent, are now giving way to unibody structures. Unibody construction integrates the vehicle's body and frame into a single, cohesive structure. Unlike body-on-frame designs, which consist of a separate ladder-like frame and body panels, unibody vehicles rely on a unified framework. Some key advantages of unibody architectures include weight reduction, enhanced safety, improved ride quality, and space optimization. Unibody designs are inherently lighter than body-on-frame counterparts. By eliminating the heavy frame, manufacturers achieve weight savings, leading to improved efficiency and handling dynamics. Unibody vehicles further distribute crash forces across the entire structure, reducing the risk of cabin deformation during collisions. Rigidity and energy absorption are superior, enhancing occupant safety. The absence of frame joints minimizes vibrations and noise, resulting in a smoother ride. Unibody vehicles exhibit better torsional stiffness, contributing to precise handling. Unibody platforms also allow for creative interior layouts, maximizing passenger and cargo space.

In unibody vehicle construction, the design of front longitudinal beams is paramount in enhancing passenger safety by effectively absorbing front impacts. These beams, typically crafted from high-strength steel, aluminum, or advanced composite materials, are strategically positioned lengthwise at the front of a vehicle to absorb collision forces efficiently. Engineered with crumple zones, these beams deform progressively upon impact, dissipating kinetic energy and reducing the transfer of force to the passenger cabin. This deliberate deformation mechanism not only absorbs the brunt of the collision but also helps to mitigate the risk of intrusion into the vehicle's interior, thereby safeguarding occupants from severe injury.

### SUMMARY

The technology disclosed herein enables enhanced front impact protection for a vehicle. In a particular example, an apparatus includes a pair of longitudinal beams extending forward from a unibody structure of the vehicle. The pair of longitudinal beams are configured to crush towards the unibody structure during an impact. The apparatus further includes a subframe mounted to the vehicle below the pair of longitudinal beams. The subframe includes an additional pair of beams parallel to the pair of longitudinal beams and the additional pair of beams include indents for encouraging the additional pair of beams to bend during the impact.

In another example, an apparatus includes a first longitudinal beam and a second longitudinal beam. Tops of the first longitudinal beam and the second longitudinal beam are less rigid than bottoms of the first longitudinal beam and the second longitudinal beam so the first longitudinal beam and the second longitudinal beam bends upward when receiving impact energy.

In one more example, an apparatus includes a unibody structure for a passenger compartment of a vehicle and a primary crash structure comprising two longitudinal beams connected at one end to the unibody structure. The primary crash structure is configured to start crushing during a front impact before a secondary crash structure is impacted. The apparatus also includes the secondary crash structure comprising a front subframe for the vehicle connected to the unibody structure. The front subframe is configured to bend upward when impacted after the primary crash structure begins crushing.

### BRIEF DESCRIPTION OF THE DRAWINGS

FIG. 1 illustrates a vehicle structure for enhanced front impact protection of a vehicle using a subframe.

FIG. 2 illustrates a top-down view of a vehicle structure for enhanced front impact protection of a vehicle using a subframe.

FIG. 3 illustrates a side-profile view of a vehicle structure for enhanced front impact protection of a vehicle using a subframe.

FIG. 4 illustrates an operational scenario for a vehicle structure for enhanced front impact protection of a vehicle using a subframe.

FIG. 5 illustrates a subframe for enhancing front impact protection of a vehicle.

FIG. 6 illustrates an operational scenario for a subframe offering enhanced front impact protection for a vehicle.

FIG. 7 illustrates a beam of a subframe for enhancing front impact protection of a vehicle.

FIG. 8 illustrates a top-down view of a beam of a subframe for enhancing front impact protection of a vehicle.

FIG. 9 illustrates a cross section of a beam of a subframe for enhancing front impact protection of a vehicle.

FIG. 10 illustrates a vehicle structure for enhanced front impact protection of a vehicle using a subframe.

FIGS. 11-13 illustrate an operational scenario for enhanced front impact protection of a vehicle using a subframe.

### DETAILED DESCRIPTION

Insufficient space for the progressive stages of longitudinal beam deformation can compromise the effectiveness of the safety mechanisms designed to absorb frontal impacts in unibody vehicles. When there is not enough room for controlled deformation, the beams may transfer more energy than desired to the passenger cabin. This scenario heightens the risk of severe injuries to occupants as the force of the collision is more directly transmitted into the vehicle's interior. Without adequate buffer zones for gradual crumpling, the impact energy could result in greater deformation of the passenger compartment, increasing the likelihood of occupants sustaining serious harm. Therefore, ensuring ample space for the controlled deformation of front longitudinal beams is typically critical to maximizing the protective capabilities of unibody vehicle structures in frontal collisions.

However, the amount of space required for the longitudinal beams limits vehicle design options. The vehicle design typically cannot reduce the distance between the front of the vehicle and the vehicle's passenger compartment below that required to fit the longitudinal beams. The examples below enable shorter longitudinal beams while still supplying an amount of crash protection afforded by longer beams, as may be required by government regulations. A vehicle can then be designed with smaller amounts of space forward of the passenger compartment without compromising safety.

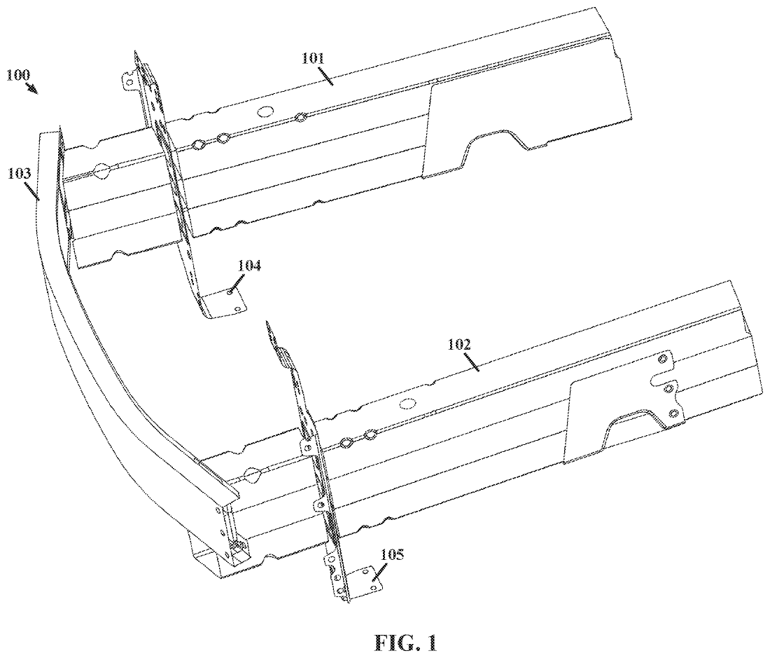

FIG. 1 illustrates vehicle structure 100 for enhanced front impact protection of a vehicle using a subframe. Vehicle structure 100 includes longitudinal beam 101, longitudinal beam 102, bumper beam 103, bracket 104, and bracket 105. While vehicle structure 100 includes a pair of longitudinal beams 101-102, other examples may include more or fewer longitudinal beams. Bumper beam 103 is affixed to one end of longitudinal beams 101-102 to direct impact energy into longitudinal beams 101-102 from across the front of the vehicle of which vehicle structure 100 is a part. Although not shown, the opposite ends of longitudinal beams 101-102 from bumper beam 103 may be affixed to a unibody structure of the vehicle. In some cases, vehicle structure 100 may be considered part of the unibody structure. While the vehicle will be discussed predominantly herein as a passenger car or sport utility vehicle (SUV), the vehicle may be any type of vehicle that may benefit from the described front impact protection, such as a truck, van, bus, or other vehicle.

In this example, longitudinal beams 101-102 are discussed as each being one continuous beam, each longitudinal beam may be produced from multiple beam segments connected together (e.g., welded, bolted, riveted, or otherwise adhered to one another). In one example, rather than brackets 104-105 attaching to longitudinal beams 101-102, brackets 104-105 may exist between two segments of longitudinal beams 101-102. Brackets 104-105 may be sandwiched between portions of longitudinal beams 101-102 connected to bumper beam 103 and portions of longitudinal beams 101-102 connected to the unibody structure. It may, therefore, be possible to just replace the portion of longitudinal beams 101-102 attached to bumper beam 103 after a more minor impact that did not affect the integrity of the remainder of longitudinal beams 101-102. Brackets 104-105 provide connection points for other vehicle components to connect to longitudinal beams 101-102. In some examples, a vehicle may be designed such that no other components require connection to longitudinal beams 101-102, or are connected using mechanisms other than brackets, and brackets 104-105 may be omitted.

Longitudinal beams 101-102 and bumper beam 103 may be produced by metal extrusion, stamping, casting, welding of components, or some other manner of producing structural components out of metal or composite material. Longitudinal beams 101-102 may be designed with varying thicknesses, shapes, and geometries along their length. The variances along longitudinal beams 101-102 enable the longitudinal beams 101-102 to undergo a controlled collapse (e.g., crumple and fold in a predetermined manner) when subjected to a front-end impact to the vehicle. This controlled deformation process helps to manage the forces transmitted to the vehicle's occupants by gradually decelerating the vehicle and extending the duration of the impact. As a result, the energy of the collision is absorbed and dissipated over a longer period, reducing the severity of injuries to occupants. In this example, longitudinal beams 101-102 include various indents to their tops and bottoms. The larger indents towards bumper beam 103 may cause longitudinal beams 101-102 to collapse near those indents first. The multiple smaller indents closely spaced on the other side of brackets 104-105 may cause that portion of longitudinal beams 101-102 to collapse next and so on. Other mechanisms for controlling the collapse longitudinal beams 101-102 may also be involved.

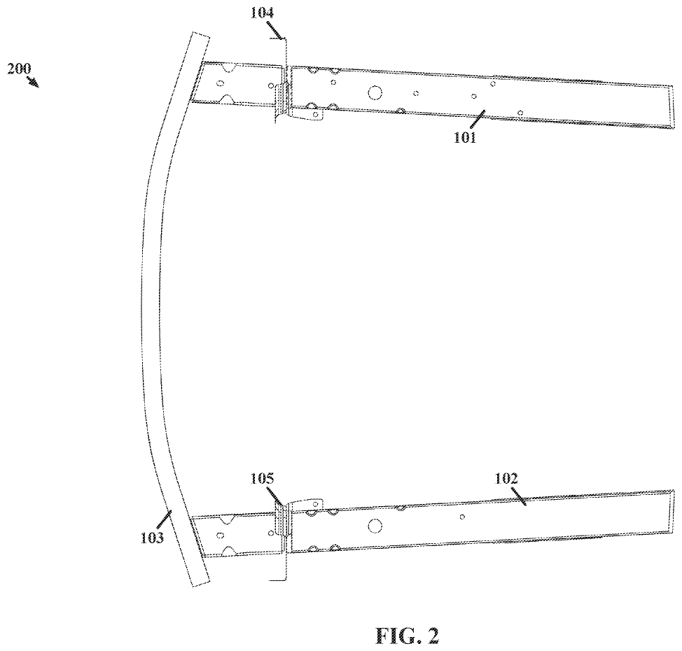

FIG. 2 illustrates top-down view 200 of vehicle structure 100 for enhanced front impact protection of a vehicle using a subframe. From top-down view 200, longitudinal beams 101-102 do not run parallel with one another. Instead, longitudinal beams 101-102 get farther away from each other towards bumper beam 103. While such an orientation may be beneficial for the purposes of an exemplary vehicle, other vehicles may have longitudinal beams 101-102 run parallel to each other, get closer at bumper beam 103, or may be arranged in some other manner.

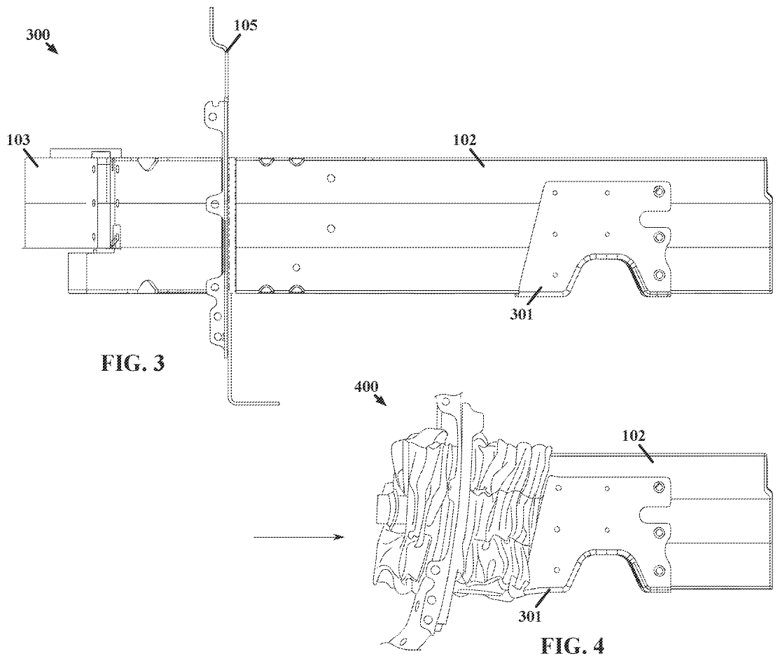

FIG. 3 illustrates side-profile view 300 of vehicle structure 100 for enhanced front impact protection of a vehicle using a subframe. Since longitudinal beam 102 and longitudinal beam 101 extend from the unibody structure level with one another, only longitudinal beam 102 and bracket 105 can be seen from side-profile view 300. Longitudinal beam 101 and bracket 104 are hidden behind. Bumper beam 103 is shown connected at one end of longitudinal beam 102. Side-profile view 300 provides a clear view of bracket 301. Longitudinal beam 101 includes a similar bracket, as can be seen in FIG. 1. Bracket 301 may provide a mounting point for vehicle components or for longitudinal beam 102 to be mounted to a portion of the vehicle. Bracket 301 may also provide additional rigidity for the gap in longitudinal beam 102 shown under bracket 301. The gap may exist to route vehicle components or allow for vehicle component movement (e.g., allow for a suspension component to move up and down). The gap and/or bracket 301 may be omitted in some examples.

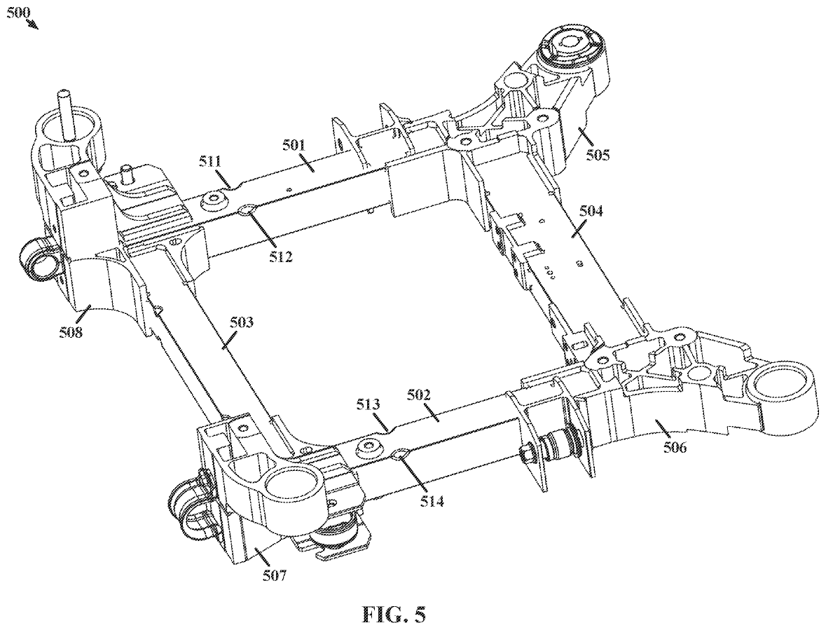

FIG. 4 illustrates operational scenario 400 for a vehicle structure for enhanced front impact protection of a vehicle using a subframe. Operational scenario 400 is an example of how vehicle structure 100 may crush due to a front-end collision of the vehicle. Energy received by bumper beam 103 from the left, as indicated by the arrow, is dissipated over a distance by longitudinal beam 102 crushing into a shorter length. Since longitudinal beam 101 still cannot be seen, it can be assumed that, for this example, longitudinal beam 101 also crushed a similar amount. Although, in other examples, an impact may be offset rather than straight on and cause one of longitudinal beams 101-102 to crush more than the other. Had longitudinal beams 101-102 not crushed, a passenger in the vehicle may absorb more impact energy resulting in greater injury.

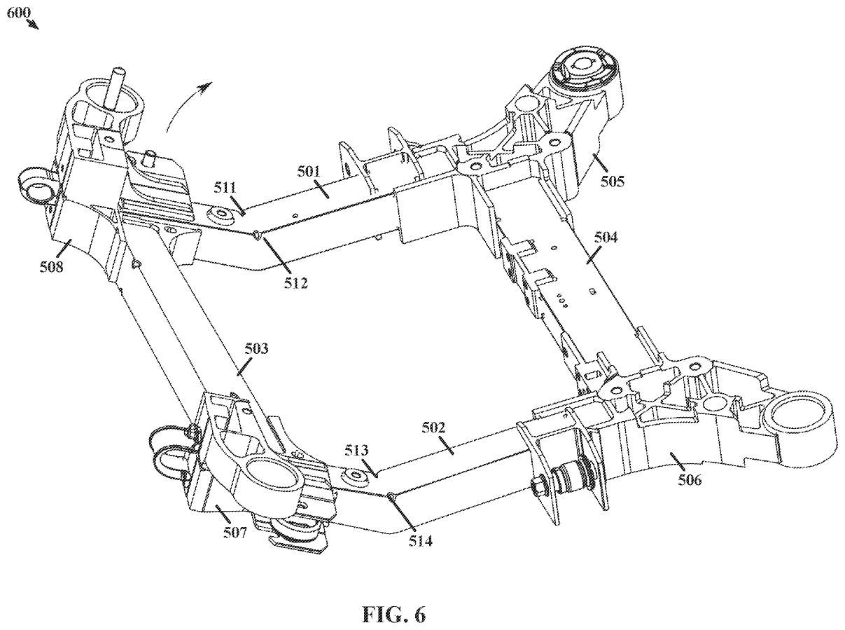

FIG. 5 illustrates subframe 500 for enhancing front impact protection of a vehicle. While the ability of longitudinal beams 101-102 to crush in a controlled manner helps to absorb impact energy, it may not absorb enough energy to prevent a desired amount of energy from being transferred to the passenger compartment of the vehicle. The desired amount of energy may be defined by government crash regulations, may be defined by some other entity, or may be obtained from some other source (e.g., the vehicle's manufacturer may want a car that is safer than the government requires). Longitudinal beams 101-102 could be elongated to extend farther in front of the vehicle to allow for more energy absorption, elongating longitudinal beams 101-102 may not allow longitudinal beams 101-102 to fit within the desired dimensions of the vehicle. Subframe 500 may be incorporated in the vehicle along with longitudinal beams 101-102 to absorb additional energy without having to elongate longitudinal beams 101-102.

Subframe 500 includes subframe beams 501-502, crossmembers 503-504, and brackets 505-508. Brackets 505-508 connect subframe beams 501-502 and crossmembers 503-504 into a substantially rectangular arrangement. In some examples, subframe beams 501-502 and crossmembers 503-504 may be connected without the use of one or more of brackets 505-508. Subframe 500 provides structural support and facilitates the integration of various components within the vehicle's front end. A front subframe is typically positioned beneath the engine and transmission or electric motor of a vehicle. The front subframe acts as a structural backbone, distributing the loads encountered during driving, such as engine torque and suspension forces, across the vehicle's structure. By anchoring crucial components like the electric motor or engine/transmission, suspension, and steering system, the front subframe enhances vehicle stability, handling, and overall performance. Moreover, a subframe helps isolate vibrations and noise from the passenger cabin, contributing to a smoother and more comfortable driving experience. The components of subframe 500 may be manufactured from metal or composite in a manner like those described above for longitudinal beams 101-102. In this example, brackets 505-508 provide mounting points for subframe 500 to attach to the vehicle and for other components, such as suspension and powertrain components, to attach to subframe 500. Different brackets or mechanisms may be used for connecting subframe 500 and other components in other examples.

Subframe beams 501-502 are rectangular hollow box beams and are not designed to crush like longitudinal beams 101-102. Instead, subframe beams 501-502 include indents 511-514. Indents 511-514 cause subframe beams 501-502 to be less rigid at the top than at the bottom where there are no indents. As such, when experiencing an impact from the front, the tops of subframe beams 501-502 will buckle before the bottoms do and cause the front of subframe 500 to bend upward. While two indents are shown per subframe beam in this example, other examples may use only fewer or more indents (e.g., one across the entire beam), openings in the beam, or some other feature that reduces the rigidity of the top side of the beam. Longitudinal beams 101-102 in vehicle structure 100 also include indents along their length but the indents at the top are paired with indents at approximately the same lengthwise position on the bottom. Thus, the indents of longitudinal beams 101-102 crush rather than bend where the indents are located.

In some examples, the location of indents 511-514 may depend on the location of one or more other components in the vehicle to encourage bending of subframe beams 501-502 at a point that minimizes potential interference by the other components or potential damage to those components. For instance, if an electric motor is mounted to subframe 500 (e.g., between or slightly above subframe beams 501-502, then indents 511-514 may be placed far enough forward on subframe beams 501-502 such that subframe beams 501-502 bend around the motor rather than contacting the motor. The motor would, therefore, not interfere with the abilities of subframe beams 501-502 to absorb at least a predetermined amount of energy. Likewise, if the motor remains undamaged, the vehicle may be somewhat operational after the collision or may be subject to a less expensive repair process due to not requiring a new motor.

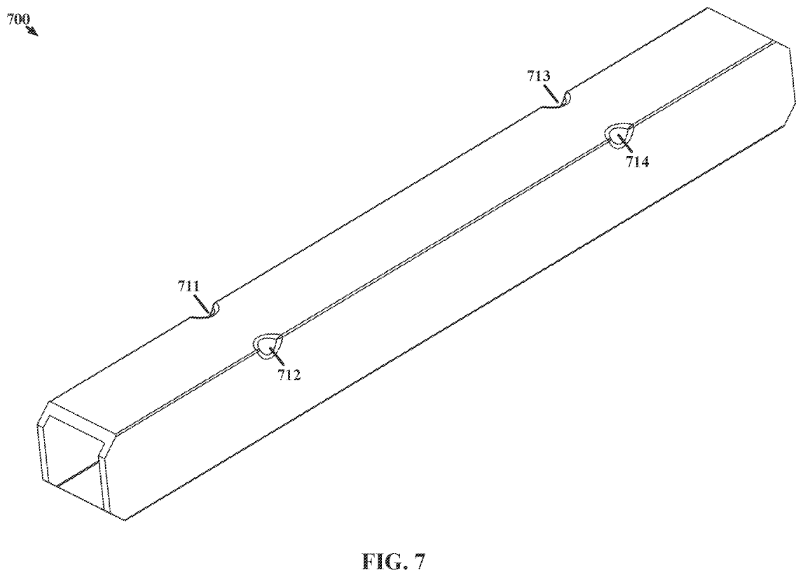

FIG. 6 illustrates operational scenario 600 for subframe 500 offering enhanced front impact protection for a vehicle. Operational scenario 600 shows what may occur to subframe 500 when absorbing the energy of a front-end impact. As said would happen above, subframe beams 501-502 have bent at indents 511-514. Indents 511-514 are smaller to show that subframe beams 501-502 are less rigid at those points and have collapsed causing the front of subframe 500 to move upward in accordance with the bending of subframe beams 501-502. It takes energy to bend subframe beams 501-502 even with indents 511-514 encouraging subframe beams 501-502 to bend in a desired direction. Thus, subframe 500 absorbs energy from a frontal impact when bending upwards. While subframe beam 501 and subframe beam 502 are shown bent approximately the same amount in this example suggesting a head-on impact, subframe beam 501 and subframe beam 502 may bend different amounts in other scenarios where the impact is offset from a direct head on collision.

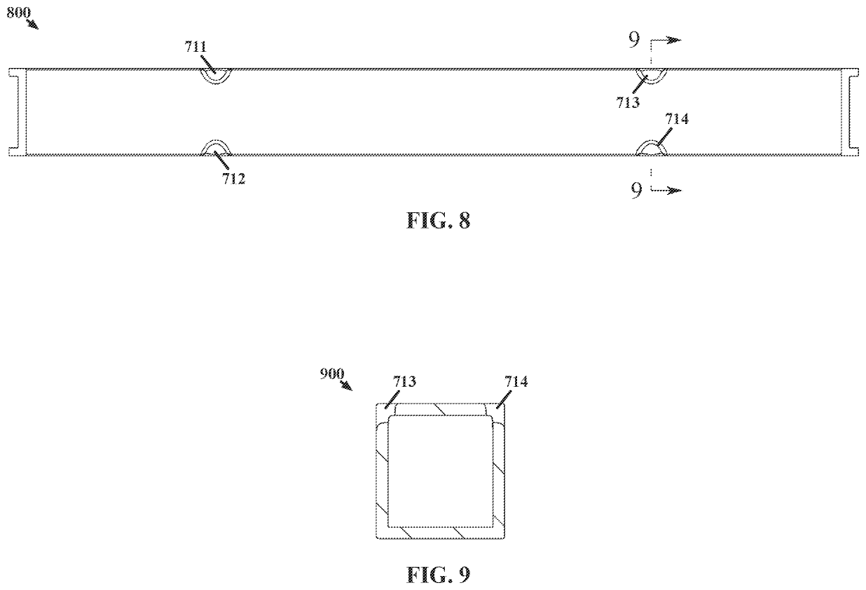

FIG. 7 illustrates beam 700 of a subframe for enhancing front impact protection of a vehicle. Beam 700 is an example of subframe beams 501-502. Beam 700 is a hollow box beam made of metal or some other composite material having characteristics allowing beam 700 to bend as described herein. Beam 700 includes indents 711-714. Indents 711-712 are examples of indents 511-514 enabling beam 700 to bend upward at position of indents 711-712. Indents analogous to indents 713-714 cannot be seen on subframe beams 501-502 due to brackets 505-506. However, analogous indents may exist enabling subframe beams 501-502 to bend upward at the location in response to further impact energy. Indents 711-712 may be different in size from indents 713-714 if different bending characteristics are desired. Indents 713-714 may be omitted in some examples.

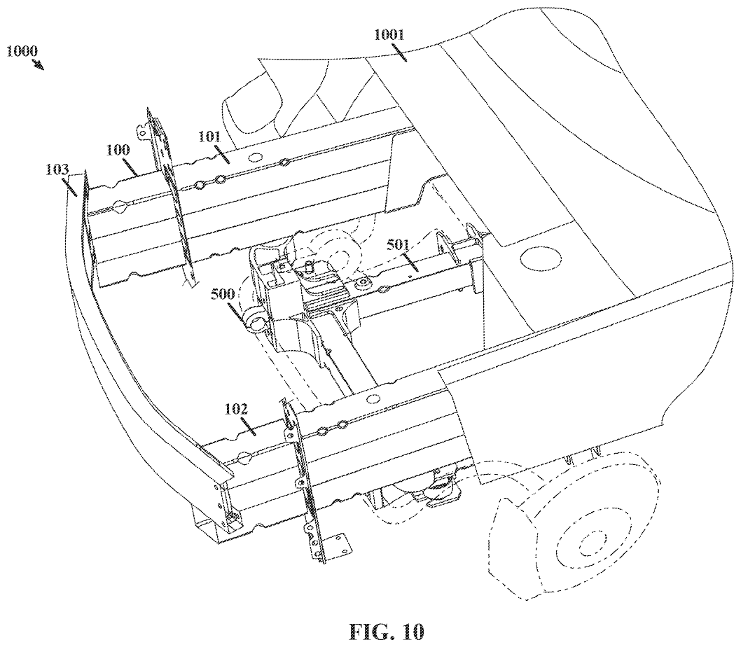

FIG. 8 illustrates top-down view 800 of beam 700 of a subframe for enhancing front impact protection of a vehicle. Top-down view 800 shows what indents 711-714 may look like from above.

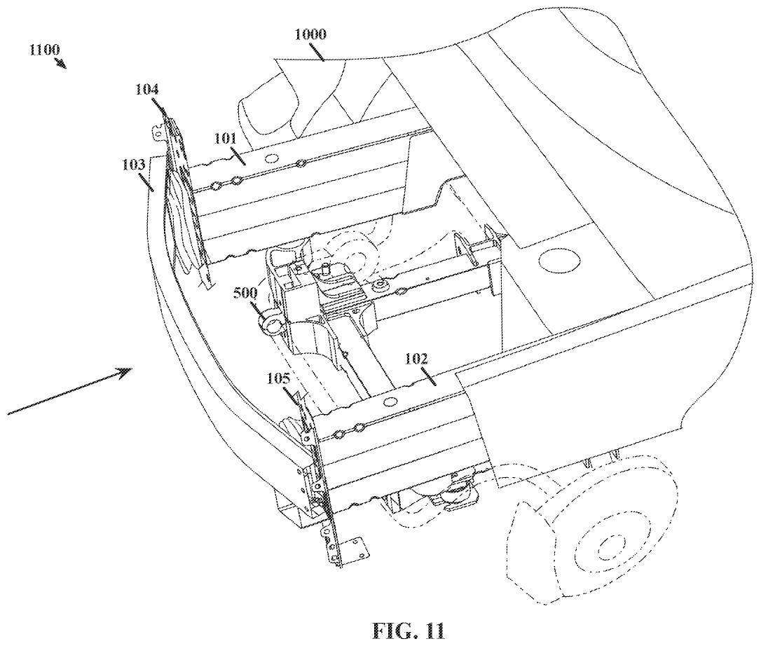

FIG. 9 illustrates cross section 900 of beam 700 of a subframe for enhancing front impact protection of a vehicle. Cross section 900 shows how indents 713-714 are formed into the corners of beam 700. Indents 711-712 may be formed similarly into beam 700 and may be different sized from indents 713-714 depending on the desired bending characteristics.

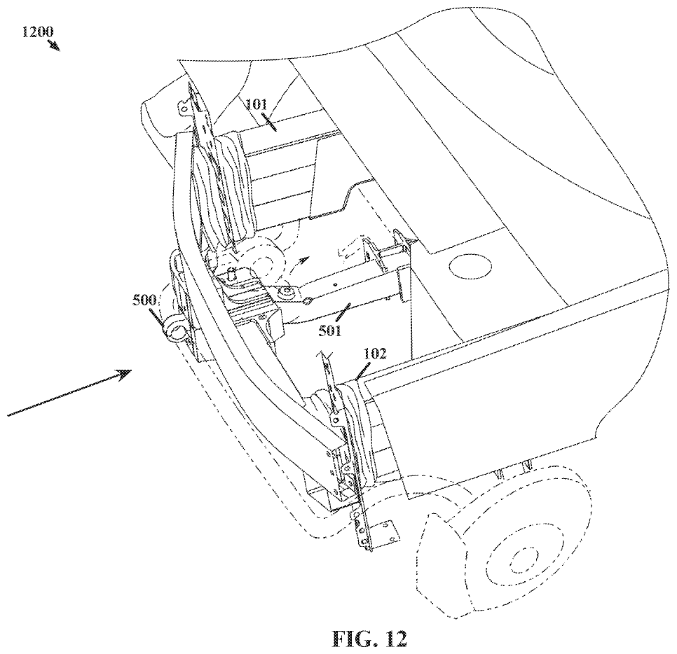

FIG. 10 illustrates vehicle structure 1000 for enhanced front impact protection of a vehicle using a subframe. Vehicle structure 1000 includes vehicle unibody 1001 having vehicle structure 100 and subframe 500 attached thereto. Vehicle structure 100 and subframe 500 may be welded, bolted, riveted, adhesively bonded, or attached to vehicle unibody 1001 using some other attachment mechanism-including combinations thereof. Vehicle structure 1000 shows how vehicle structure 100 is positioned relative to subframe 500 and provides an example for where front suspension components may exist relative to subframe 500. Since subframe 500 starts further back towards vehicle unibody 1001, subframe 500 does not assist in impact absorption until the impact energy is great enough to collapse vehicle structure 100 to reach subframe 500. In some examples, subframe 500 may be positioned differently relative to vehicle structure 100 depending on desired impact absorption characteristics. For instance, subframe 500 may start further forward relative to vehicle structure 100 to assist with energy absorption sooner in the event of a frontal impact.

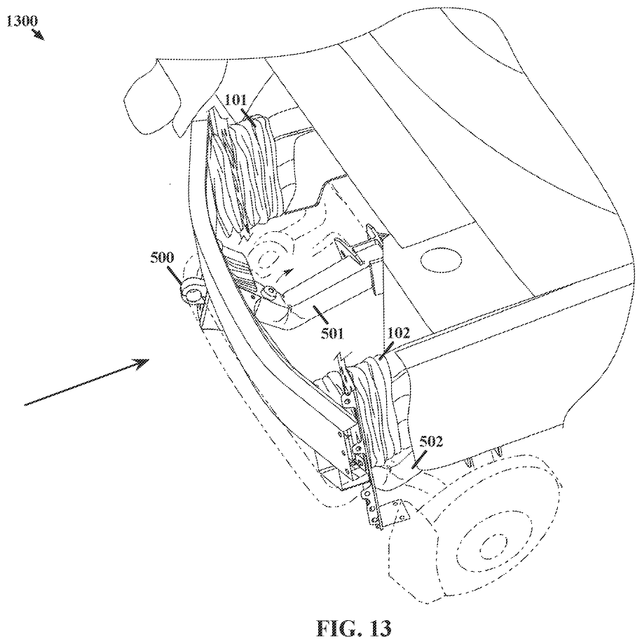

FIGS. 11-13 illustrate an operational scenario for enhanced front impact protection of a vehicle using a subframe. The operational scenario comprises a direct front-end impact to vehicle structure 1000. FIG. 10 shows an example of how vehicle structure 1000 may look prior to the impact results shown in FIGS. 11-13.

FIG. 11 illustrates stage 1100 of the operational scenario. At stage 1100, longitudinal beams 101-102 have crumpled from absorbing impact energy directed at the front of bumper beam 103. As designed, the portion of longitudinal beams 101-102 between brackets 104-105 and bumper beam 103 has crumpled first. If this first portion was able to absorb all the energy of the impact, then vehicle structure 1000 will remain in the state shown in stage 1100.

FIG. 12 illustrates stage 1200 of the operational scenario should additional energy from the impact be absorbed by vehicle structure 1000. At stage 1200, the portion of longitudinal beams 101-102 behind brackets 104-105 from bumper beam 103 have also crumpled. At some point during the crumpling, bumper beam 103 came in line with the front of subframe 500. As such, whatever object is causing the impact force (e.g., another vehicle, a barrier, a pole, etc.) began transferring energy into subframe 500. Subframe beam 501 has begun bending upward to absorb the impact energy now being transferred to subframe 500. Subframe beam 502 is also bending upward but cannot be seen due to longitudinal beam 102 being in the way from this viewpoint. Once subframe 500 began being impacted, the energy from the impact was being transferred into subframe 500 along with longitudinal beams 101-102 rather than longitudinal beams 101-102 shouldering the entire load.

FIG. 13 illustrates stage 1300 of the operational scenario should even more energy from the impact be absorbed. Longitudinal beams 101-102 have absorbed more energy and crushed even further than at stage 1200. Subframe beams 501-502 of subframe 500 have likewise bent further as subframe 500 absorbed more energy as well. Enabling the subframe to absorb energy in a controlled manner enables vehicle structure 1000 to absorb more energy with the same configuration (e.g., dimensions, geometry, shape, etc.) of longitudinal beams 101-102. If longitudinal beams 101-102 are not capable of absorbing enough impact energy on their own, the addition of subframe 500 absorbs additional energy without having to modify longitudinal beams 101-102 beyond what may be desired for the vehicle (e.g., no need to make the front of the vehicle longer to lengthen longitudinal beams 101-102).

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

In the claims:

1. An apparatus for front impact structure for a vehicle, the apparatus comprising:
a pair of longitudinal beams extending forward from a unibody structure of the vehicle, wherein the pair of longitudinal beams are configured to crush towards the unibody structure during an impact; and
a subframe mounted to the vehicle below the pair of longitudinal beams, wherein the subframe includes an additional pair of beams parallel to the pair of longitudinal beams, wherein the additional pair of beams include indents for encouraging the additional pair of beams to bend during the impact, and wherein a portion of the pair of longitudinal beams forward of the subframe is replaceable independently from a remainder of the pair of longitudinal beams and configured to crush prior to compromising integrity of a remainder of the pair of longitudinal beams.

2. The apparatus of claim 1, wherein each longitudinal beam of the pair of longitudinal beams crushes progressively after the portion crushes.

3. The apparatus of claim 2, wherein at least the portion crushes prior to the additional pair of beams beginning to bend.

4. The apparatus of claim 3, wherein the additional pair of beams does not receive impact energy until after the portion crushes.

5. The apparatus of claim 1, wherein brackets separate the portion from the remainder.

6. The apparatus of claim 1, wherein a bumper is affixed to an end of the pair of the longitudinal beams opposite from the unibody structure.

7. The apparatus of claim 1, wherein the subframe further includes first and second cross members connecting the additional pair of beams.

8. The apparatus of claim 1, wherein vehicle suspension components are mounted to the subframe.

9. An apparatus for a vehicle structure, the apparatus comprising:
a first longitudinal beam;
a second longitudinal beam parallel to the first longitudinal beam, wherein portions of the first longitudinal beam and the second longitudinal beam forward of a first subframe beam and a second subframe beam running parallel to the first longitudinal beam and the second longitudinal beam are replaceable independently from a remainder of the first longitudinal beam and the second longitudinal beam and configured to crush prior to compromising integrity of remainders of the first longitudinal beam and the second longitudinal beam;
the first subframe beam; and
the second subframe beam, wherein tops of the first subframe beam and the second subframe beam are less rigid than bottoms of the first subframe beam and the second subframe beam so the first subframe beam and the second subframe beam bend upward when receiving impact energy.

10. The apparatus of claim 9, wherein indents in the tops cause the tops to be less rigid.

11. The apparatus of claim 10, wherein the first subframe beam and the second subframe beam are box beams and the indents are in upper corners of the box beams.

12. The apparatus of claim 9, wherein openings in the tops cause the tops to be less rigid.

13. The apparatus of claim 9, wherein an electric motor is mounted between the first subframe beam and the second subframe beam.

14. The apparatus of claim 9, comprising:
a plurality of brackets separating the portions from the remainders.

15. The apparatus of claim 14, wherein suspension components mount to the plurality of brackets.

16. An apparatus for a vehicle structure, the apparatus comprising:
a unibody structure for a passenger compartment of a vehicle;
a primary crash structure comprising two longitudinal beams connected at one end to the unibody structure, wherein a portion of the primary crash structure is configured to crush during a front impact before a secondary crash structure is impacted, and wherein the portion is replaceable independently from a remainder of the primary crash structure; and
the secondary crash structure comprising a front subframe for the vehicle connected to the unibody structure, wherein the front subframe is configured to bend upward when impacted after the primary crash structure begins crushing.

17. The apparatus of claim 16, wherein the front subframe comprises a rectangle of beams to which vehicle propulsion and suspension components are mounted.

18. The apparatus of claim 16, wherein the primary crash structure progressively crushes in three stages with the portion comprising a first of the three stages.

19. The apparatus of claim 18, wherein the front subframe begins to bend during a second of the three stages.

20. The apparatus of claim 16, wherein indents in the front subframe cause the front subframe to bend upward.
